(19) United States
(12) Patent Application Publication
(10) Pub. No.: US 2010/0094439 A1
(43) Pub. Date: Apr. 15, 2010

(54) SYSTEM FOR SELECTING AND CONTROLLING LIGHT SETTINGS

(75) Inventors: Dennis Van De Meulenhof, Eindhoven (NL); Fiona Rees, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/439,307

(22) PCT Filed: Sep. 3, 2007
(86) PCT No.: PCT/IB2007/053544

§ 371 Date: Nov. 24, 2009

(30) Foreign Application Priority Data
Sep. 12, 2006 (EP) 06120531.6

(51) Int. Cl. G06F 17/00

(52) U.S. Cl. 700/90

(57) ABSTRACT

An interactive method and system include a card (310) including scene data, a reader (320) configured to read the scene data, and a processor (350) configured to activate at least one controllable device (340) in accordance with the scene data to provide a scene associated with the scene data. The controllable device, such as a light source and/or a projector/display is activated in response to inserting the card (310) into a slot of the reader (320) or placing card on (310) a surface (232) of the reader (320). The processor (350) is configured to allow for adjustment of attributes of the scene by a user, including changing intensity and/or color of the scene or of the controllable devices (340) that provide the scene.

The present invention relates to an interaction system for selecting and controlling light settings in a lighting control system, for example, in response to inserting cards or any tags into a card/tag reader.

Innovative lighting control systems are introduced in both the professional (e.g., building, shop, hotels) and consumer (e.g., home) market. These systems allow control of all the surrounding lights, such as dimming, switching on/off and color adjustments in order to provide an enriching experience and improve productivity, safety, efficiency and relaxation. It is desirable to offer simple and intuitive user interfaces and to mask the system complexity from the user. In other words, it is desirable to make the control interfaces (with their own comprehensive physical appearances) and user interactions such that they match the mental model in the user's mind.

Controlling a lighting system in an easy and intuitive way, while masking the system complexity, is a challenge on its own. Solutions exist for different interaction paradigms (e.g., selection of control functions) of controlling (e.g., dimming or changing color) individual light sources. Although these solutions are tailored to individual light sources, they often are extended to the system solution as well. However, from a user perspective, the user's mental model does not match with the available control systems and their responses to user actions, thus leading to confusion and frustration.

Further, even more user confusion occurs when different individual solutions are combined in a system where also different interaction paradigms are combined. Note that even in the case when a single paradigm is used, changing the setting of an individual light source will influence the perception of the light coming from other light sources, and thus influencing or changing the total light experience (referred to as system effect). Accordingly, there is a need for simpler and better user interfaces which are intuitive and mask system complexity, allowing for automatic selection of preferred/predetermined (settings of) light sources and control thereof.

One object of the present systems and methods is to overcome the disadvantages of conventional interactive systems.

According to illustrative embodiments, interactive methods and systems comprise a card including scene data, a reader configured to read the scene data, and a processor configured to activate at least one controllable device in accordance with the scene data to provide a scene associated with the scene data. The controllable device, such as a light source and/or a projector/display is activated in response to inserting the card into a slot of the reader or placing card on a surface of the reader, for example. The processor is configured to allow for adjustment of attributes of the scene by a user, including changing intensity and/or color of the overall scene or of individual or grouped controllable devices that contribute to and provide the scene.

Further areas of applicability of the present systems and methods will become apparent from the detailed description provided hereinafter. It should be understood that the detailed description and specific examples, while indicating exemplary embodiments of the systems and methods, are intended for purposes of illustration only and are not intended to limit the scope of the invention.

These and other features, aspects, and advantages of the apparatus, systems and methods of the present invention will become better understood from the following description, appended claims, and accompanying drawing where:

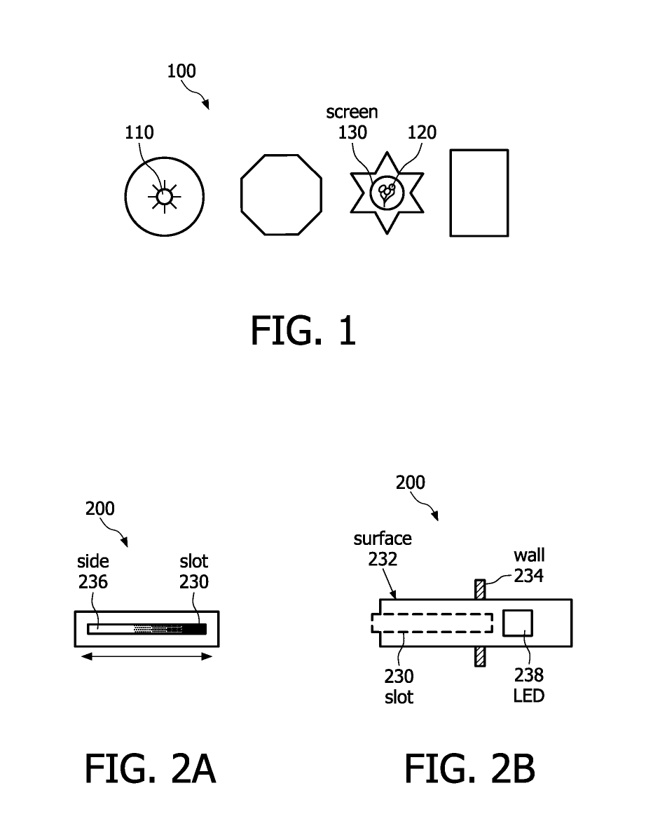

FIG. 1 shows various cards according to illustrative embodiments of the present invention;

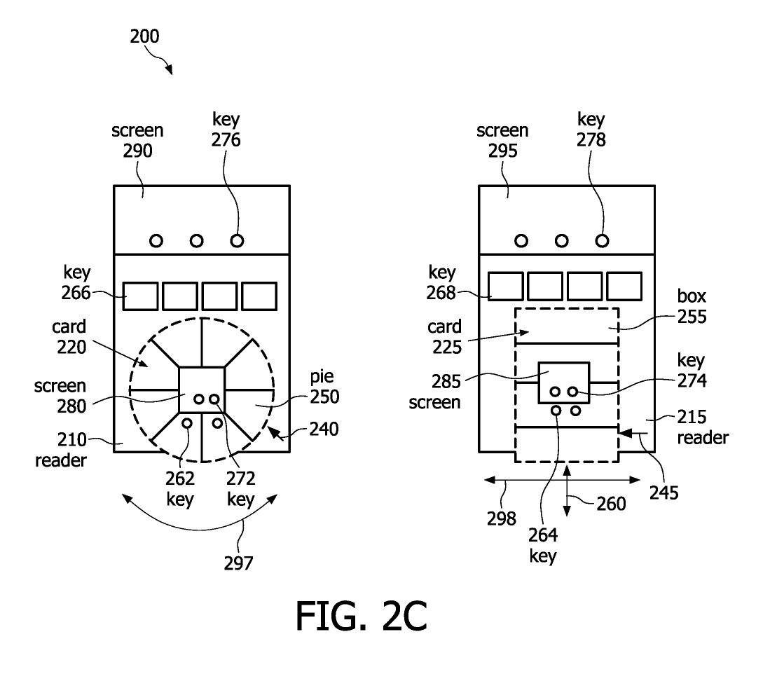

FIGS. 2A-2C show an interaction system according to another illustrative embodiment of the present invention; and

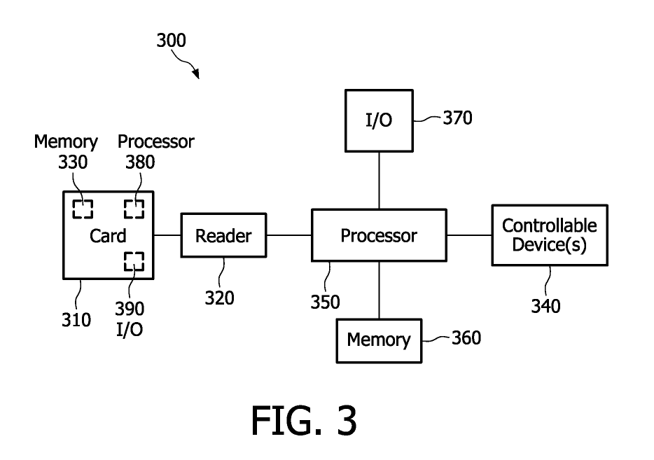

FIG. 3 shows a block diagram of the interaction system shown in FIG. 2.

The following description of certain exemplary embodiments is merely exemplary in nature and is in no way intended to limit the invention, its applications, or uses. In the following detailed description of embodiments of the present systems and methods, reference is made to the accompanying drawings which form a part hereof, and in which are shown by way of illustration specific embodiments in which the described systems and methods may be practiced. These embodiments are described in sufficient detail to enable those skilled in the art to practice the presently disclosed systems and methods, and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices, circuits, and methods are omitted so as not to obscure the description of the present system.

Systems and methods according to various embodiments offer a set of light scenes as a starting point and allow individual control of various scenes and/or light source attributes of individual or grouped controllable light sources to adjust to the user's personal preferences, thus easily selecting and adjusting a desired scene starting from an initial scene. For example, a card and reader combination offers the selection from one or multiple scenes as a starting point and “in one go” allows for adjustment of the selected scene. Illustrations that show the moods of the scenes are visualized on the card. These visual illustrations serve as an initial selection aid for the user. Once the card is inserted into reader, for example, which may be a slot in a wall of a room, the scene becomes active and the card interface, while still remaining in the reader, and/or the reader interface can be used to adjust the selected scene. For example, in the case where the card has a disc shape then scene control, such as dimming or changing color of the scene, may be achieved by rotating the disc in the reader slot in a dimming or color changing mode, respectively.

FIG. 1 shows several shaped cards 100, such as circular, octagon, star-shaped and rectangular shaped cards. Of course, the cards 100 may have any other shape, such as a heart shape with or without a romantic illustration indicating a starting scene related to romance, such as having dimmed lights, where predefined starting color(s), such as the entire scene soft red, or soft red in one corner, soft green and blue illumination in other parts of the scene or room, etc. FIG. 1 shows the circular card including an illustration of a sun 110, indicating a bright scene where light sources provide bright illumination of the environment, such as a room for example.

Other shapes and/or illumination may be used to suggest scenes associated with the cards, such as a moon shaped card and/or illustration on a card suggestion a night scene, where lights are dimmed and have an appropriate color or color temperature, for example. The star shaped card, or any other shaped card may have illustration indicating a party setting, such as an illustration of balloons 120 for example, where inserting such a card provide a party scene or atmosphere where different intensity and colored light may be provided by light sources and/or projectors/screen displays. The illumination may be variable over time, such as strobe lights turning on/off, lights that change directions steerable or rotateable either physically or electronically, e.g., showing a sun or a moon moving along a wall or ceiling of the room for example. A book shaped card would provide a default or initial scene and/or illumination suitable for reading, while a TV shaped card would provide a default or initial scene and/or illumination suitable for watching TV, for example. Any desired predetermined shape, illustration and/or scene may be used to provide an initial predetermined scene(s), such as a book shaped and/or illustrated key for reading for example.

Of course, in addition to controlling lights, other functions or actions may be associated with the cards. For example, inserting the party card into the card reader turns on party music in addition to the party illumination or scene. The party scene and associated lights may change with or follow the music, such as the tempo, the beat, and/or the volume, for example. Similarly, inserting the romantic card initiates soft music in addition to the soft lighting, for example.

In a hotel room setting, inserting a card into the reader may also lock the door. One of the cards may also be a key card, thus when a guest arrives and insert the card into a slot in the door, the door unlocks and lights are turned on in accordance with a welcome scene programmed and stored in the card by the hotel management. A card that unlocks doors is described in U.S. Patent Application Publication Number 2006/0037372 to Jones, which is incorporated herein by reference in its entirety. The card reader may be operationally coupled to other devices and may automatically react in response to user actions associated with the other devises.

For example, when the guest turns on the television (TV), or orders a pay per view television program or video on demand, then the reader adjusts the lights to provide a better ambiance to watch the TV/selected program. A processor of the reader may also be configured to receive and analyze the content of the TV program and control the lights in accordance with the analyzed content. For example, along with an explosion or accident scene, the lights may be controlled to strobe or provide short duration intense flashes of light that are matched to the explosion or accident scene. Of course, instead of analyzing the content, the controllable devices including light sources may follow the video or audio content based on scripts associated with such content that may be broadcast along with the content, or stored in a memory of the interaction system including a remote memory accessible (via any network, such as the Internet) by the interaction system, a memory of the card and/or a memory of the card reader, for example.

Of course, upon providing the initial illumination, scene or setting in response to inserting the card into the reader for example, the user may control various light or scene attributes, such as changing light attributes of the entire scene and/or desired portion(s) of the scene including portions of the light sources to provide light with different attributes, such as different intensities and/or color, as well as control further characteristics of the scene, such as lowering the music or changing it. Further, each card may contain more than one scene, which may be selected by the user before or after insertion into the reader, such as via a user interface of the card or of the reader.

Several pictures or illustrations may be provided on the card, either simultaneously or sequentially, such as displayed on a screen 130 of the card displaying the balloons 120 in FIG. 1. The card screen 130 may be any type of a screen display, such as a liquid crystal display (LCD) screen for example. The illustrations may be sequenced upon user interaction to go to the next or previous scene illustration and/or activation of (lighting) scenes associated with the illustrations. The user interaction may include activation of keys for mode selection and/or scene or illumination adjustments. Further user interaction may include moving (e.g., rotating or sliding) the card relative a marker on the reader as will be described.

The interaction system 200 including a card and reader shown in FIGS. 2A-2C may have several modes which may be selecting by toggling a key of the card and/or or reader. For example, one mode may be a color changing mode, while another mode may be an intensity changing mode. Further, in an automatic mode, a scene may be activated automatically upon selection thereof, such as a positioning the card near the reader or near an arrow of the reader, as will be described. Of course, instead of an automatic mode, where a scene activated automatically upon selection thereof, the system may have an acknowledge mode, where the system may prompt the user whether to accept or reject the activation, showing previews of the scene on a display of the card, of the reader, or any other display. Keys may be activated to navigate among the various modes, scenes and other features of the system, including selecting modes associated with control functions of the system's user interfaces, or selecting modes (e.g., dimming mode) associated with light attributes of the scene and/or individual or grouped controllable devices including light sources, for example. Illustratively, a first push or activation of a mode key enters or activates a dimming mode, a next push activates a color temperature mode, etc., thus sequencing through the various available control features and modes.

The card provides the user an initial or default selection(s). This initial selection matches best the mood or activity of the user. The number of pictures shown depends on the shape and size of the card or its screen. One might decide to offer the user only one card showing multiple scenes on both sides, or to offer the user multiple cards showing only one scene on one side, for example.

FIGS. 2A-2C show front, side and top views of the interaction system 200 including at least one card and reader, where the top views of a card reader 210, 215 show a circular card 220 and non-circular card such as a rectangular card 225 inserted in a slot 230 (FIGS. 2A and 2B) of respective card readers 210, 215. It should be understood the slot 230 may be any type of input device capable of accepting a card and reading data stored thereon. For example, as shown in the FIG. 2B, the input device may be any surface in lieu of or in addition to the slot 230, such as the top surface 232 of the card reader where the card is placed, where the surface 232 extends from a wall 234 holding the reader, for example, and slideably holds the cards allowing sliding, including rotational, movement of the card for example.

Once the card is inserted into or placed on the card reader 210, 215, the scene associated with, or stored in, a selected card will be activated. It should be understood that the card may be read by the reader and thus, in response thereof, a scene activated, by any other way or positioning that effectuates communication between the card and the reader, including wired or wireless communication such as radio frequency (RF), Infrared (IR), optical, using any desired protocol such as Bluetooth or Zigbee, for example, where for example bringing the card within a certain distance of the reader activates the associated initial scene, for example.

A card that is programmed to transmit to a microprocessor signals that include personal lighting preferences of a user, so that room lights are controlled in accordance with the personal lighting preferences when the user is in proximity of a receiver is described in U.S. Pat. No. 7,038,398 to Lys et al., which is incorporated herein by reference in its entirety. A card reader that provides personal lighting conditions when a user enters a room is described in Japanese Patent Publication Number JP 06-310284 to Hideo et al., which is incorporated herein by reference in its entirety. Further, a remote controller with a screen to control color and brightness is described in Japanese Patent Publication Number JP 62-299097 to Junichi, which is incorporated herein by reference in its entirety.

For cards having multiple scenes stored therein or accessible thereby, where associated icons, illustrations, or any other representation of the associated scenes are displayed on the card, then one of the scenes may be selected by positioning the preferred or selected scene near a marker on the reader 210, 215. Any type of marker on the reader 210, 215 may be used such as an arrow or other indications including light emitting diodes (LEDs), where arrows 240, 245 are shown in FIG. 2.

As shown in FIG. 2C, multiple scene representations may be displayed as semi-pie shaped scenes illustrations 250 for the circular disk 220, and box shaped (e.g., rectangular) scenes 255 displayed on the rectangular disk 225. For the circular disk 220, one of the as pie shaped scenes 250 may be selected by rotating the circular disk 220 to position the selected pie shaped scene near the arrow 240. For the rectangular disk 225, one of the box shaped scenes 255 may be selected by sliding (in toward or away from the card reader as shown by arrow 260) the rectangular disk 225 to position the selected box shaped scene illustration/representation 255 near the arrow 245.

The card and/or reader may have hardware keys 262, 264, 266, 268, or software keys 272, 274, 276, 278, such as on a card touch screen 280, 285 and/or on a reader touch screen 290, 295 to effectuate various functions, while communicating with the reader, such as communicating wirelessly while the card is inserted into, or placed on, the reader. For example, a key on the card and/or reader may be used to toggle among various modes or scenes, where an indication of the current mode or scene may be displayed on the card screen 280, 285 and/or a reader screen 290, 295.

Once the selected scene is activate, e.g., upon card insertion into the slot or card placement on a reader surface 232, the activated scene may then be controlled via the user interface of the reader and/or the card in the case the card is placed on the reader surface 232 and has accessible interface keys and/or screen.

In addition or in lieu of using card/reader interface keys/screens, controlling the activated scene may by performed by moving the card in particular directions depending on the shape of the card. For example, scenes or individual lighting units or other controllable devices may be selected and/or controlled by rotating the circular or disk shaped card 220 in a clockwise or counter clockwise direction 297, or by sliding the rectangular card 225 to the right or left direction 298.

Of course, further user interface control devices may be included in the card or reader. For example, the side surface 236 of the card that remains visible upon insertion of the card in slot 230, as shown in FIG. 2A, may include a display screen that displays gradients for dimming and/or color temperature control of the scene or of selected individual or grouped light sources, such as by sliding a finger over the surface 236 to the right or left, for example. Instead of a card side screen to display intensity or color gradient, the card may include light guiding material that guide images of the intensity or color gradient to the cards side surface 236 from the reader, such as from a screen of the reader or LEDs located on or near the reader, for example, such as the LED 238 shown in FIG. 2B.

FIG. 3 shows a block diagram 300 of the interaction system 200 shown in FIG. 2. As shown in FIG. 3, a card 310 is operationally coupled to a reader 320 which reads data included in a memory 330 of the card 310, such as an initial scene settings of at least one controllable device 340. Various controllable devices 340 may be provided including at least one light source and/or projector that illuminate an environment and/or project desired images on surfaces such as walls or ceiling of a room, including still images or streaming video, in accordance with scene data stored in the card memory 330, for example. The light source(s) and/or projector(s) may be steerable physically or electronically, to provide illumination or image in desired directions such as through steerable mirrors for example.

The reader 320 is operationally coupled to a processor 350 configured to perform desired operational acts as described, such as upon execution of instructions based on a program(s) stored in a system memory 360 and/or the card memory 330 as read by the reader 320. The system memory 360 stores other data for system operation, such as an operating system and the like. For example, the processor 350 may be configured to activate scenes in response to the reader 320 reading the scene data from the card memory 330. Of course, the scene data may be stored in the system memory 360, or any other accessible memory, such as via a network like the Internet, in which case the card memory 330 includes a link, address, pointer or indication as to which scene data is to be accessed and activated.

The processor 350 is also operationally coupled to the various input/output (I/O) devices 370, such as a display, hardware keys, or software keys displayed on the display which may be a touch display, mouse, pointer and the like. Further as described and in addition to having a card memory 330, the card 310 may also have a card processor 380 and card I/O with keys, hard or soft, a display 390 and the like.

Of course, the reader may be a portable reader, or a further portable reader may be provided in addition to a reader fixed to a room surface such as the wall 234 shown in FIG. 2B. The portable reader communicates with the system processor 350 and/or the card 310 though any wireless channel, such RF, IR, laser, sonar and the like. Similarly, the system processor 350 may wirelessly communicate and control the controllable devices 340 which may have various devices such as transceivers and unique identifications (IDs) or tags, such as RFID tags and readers as needed or desired, where similar to devices may be included in the card and/or reader. Of course instead of wireless communication, any communication may also be effectuated through wires, cable, fiber optics and the like.

It should be understood that the interaction systems and methods are applicable in many situations, such as homes, offices, commercial establishments, hotels and the like. For example, hotels may provide a differentiating service or luxury by offering sophisticated yet easy-to-access lighting and scene interaction systems as described, thus providing lighting effects that enables many different guests to derive a greater sense of belonging, personalization and pleasure from the same hotel room, where the mood of a room is changeable. For example, the hotel guest may be provided with various cards for various scenes, such as welcome, soothing, refreshing, cozy, sensual and wild scenes that are defined in terms of the mood, feeling or effect that might accompany various activities.

Other devices may also be operationally coupled to the interactive system, such as touch-sensitive surfaces, display surface such as on entire or portions of a wall, LEDs, light and motion sensors and timers enable a desired level of subtlety and gentleness in interface behavior and response to create sophisticated lighting effects that gracefully change over time. That is, a selected scene may remain constant over time or may be variable where settings changes based on predetermined or selected criteria, such as time of day, temperature, mood, scenes, etc, changing over at predetermined or selected periods or events, such as detecting additional people in the room via motion sensors, for example.

Illustratively, if a lot of people are detected in a room and it's daytime, then bright lights may be provided at certain dark locations of the room away from window, or incase the shades are closed, as detected by light sensors, for example. Mixed sources like LED and LED-lens combinations or any other controllable light source may bring a multitude of light textures that enliven a space in a myriad of ways.

Control of the interaction system may include dragging a finger across a slider control situated on the reader for example, hardware or software, or the card such as on the surface 236 shown in FIG. 2A. In response to the finger dragging, the brightness, color and/or or warmth of the light gradually changes, e.g., fades, to reflect the user's personal preference. The system interaction may be configured to gradual change with little or no abrupt changes to the lighting that may upset the user's mood.

Touching the slider in any location and an LED level indicator, for example, may slowly move towards the finger, ensuring a graceful transition in light effect and changing the part or all scene or illumination as it moves. Once the indicator is under or near the finger, the indicator will move with the finger, responding to the finger movements in a way that supports a request for quick change e.g., by quickly moving the finger, yet reducing or eliminating abrupt jumps or irritating changes in brightness or color changes, for example.

Once in bed, as detected by motion sensors or camera, the interaction system may be configured to turn on or be ready to turn on a nightlight as needed. For example, if it is detected that the user or guest stepped out of bed during the night, a gentle light is automatically activated and glows across the floor to guide the user. A combination of sensors and timers perform a double check, ensuring that the floor is illuminated only when appropriate.

Of course, as it would be apparent to one skilled in the art of communication in view of the present description, various elements may be included in the system components for communication, such as transmitters, receivers, or transceivers, antennas, modulators, demodulators, converters, duplexers, filters, multiplexers etc. The communication or links among the various system components may be by any means, such as wired or wireless for example. The system elements may be separate or integrated together, such as with the processor. As is well-known, the processor executes instruction stored in the memory, for example, which may also store other data, such as predetermined or programmable settings related to system interaction, setting for the scenes illuminating a room, for example.

It should be understood that the various component of the interaction system may be operationally coupled to each other by any type of link, including wired or wireless link(s), for example. Various modifications may also be provided as recognized by those skilled in the art in view of the description herein. The memory may be any type of device for storing application data as well as other data. The application data and other data are received by the controller or processor for configuring it to perform operation acts in accordance with the present systems and methods.

The operation acts of the present methods are particularly suited to be carried out by a computer software program, such computer software program preferably containing modules corresponding to the individual steps or acts of the methods. Such software can of course be embodied in a computer-readable medium, such as an integrated chip, a peripheral device or memory, such as the memory or other memory coupled to the processor of the controller or light module.

The computer-readable medium and/or memory may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory.

Additional memories may also be used. The computer-readable medium, the memory, and/or any other memories may be long-term, short-term, or a combination of long-and-short term memories. These memories configure the processor/controller to implement the methods, operational acts, and functions disclosed herein. The memories may be distributed or local and the processor, where additional processors may be provided, may be distributed or singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory, for instance, because the processor may retrieve the information from the network.

The processors and the memories may be any type of processor/controller and memory, such as those described in U.S. 2003/0057887, which is incorporated herein by reference in its entirety. The processor may be capable of performing operations in response to detecting user's gazes, and executing instructions stored in the memory. The processor may be an application-specific or general-use integrated circuit(s). Further, the processor may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Of course, it is to be appreciated that any one of the above embodiments or processes may be combined with one or with one or more other embodiments or processes to provide even further improvements in finding and matching users with particular personalities, and providing relevant recommendations.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same or different item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. An interaction system comprising:
a card including scene data;
a reader configured to read said scene data; and
a processor configured to activate at least one controllable device in accordance with said scene data to provide a scene associated with said scene data,
wherein said card has at least one of a shape and illustration associated with an initial setting of said scene.

2. The interaction system of claim 1, wherein said at least one controllable device is activated in response to at least one of inserting said card into a slot of said reader and placing said card on a surface of said reader.

3. The interaction system of claim 1, wherein said processor is configured to adjust at least one attribute of said scene.

4. The interaction system of claim 3, wherein said adjustment is effected by at least one of rotating a circular card and sliding a non-circular card.

5. The interaction system of claim 1, wherein said scene data include information of a plurality of scenes, one of said plurality of scenes being selectable based on a position of said card relative a marker of said reader.

6. The interaction system of claim 1, wherein said scene includes illuminating a room with at least one of light from at least one light source and projecting at least one image on at least one surface of said room.

7. The interaction system of claim 6, wherein said at least one image includes at least one of a still image and a video stream.

8. The interaction system of claim 1, wherein at least one of said card and said reader includes at least one of a key and a display.

9. A card comprising:
a memory for storing attributes associated with at least one scene;
a screen configured to display an indication of said at least one scene;
at least one key configured to provide in input signal; and
a processor configured to cycle through different scenes stored in said memory and to cycle through different indications displayed on the screen associated with the different scenes in response to the input signal, wherein said card has a shape associated with an initial scene stored in said memory.

10. (canceled)

11. The card of claim 9, wherein said at least one key is one of a hardware key and a software key displayed on said screen.

12. The card of claim 9, further comprising a light guide configured to guide light from in input port to at least one surface of said card, said at least one surface being illuminated with a gradient of an attribute of said light.

13. An interaction method comprising the acts of:
positioning a card within proximity of a reader;
reading scene data in response to the positioning act; and
activating at least one controllable device in accordance with said scene data to provide a scene associated with said scene data, wherein said card has a shape associated with said scene data stored in a memory of the card.

14. The interaction method of claim 13, wherein the positioning act includes at least one of inserting said card into a slot of said reader and placing said card on a surface of said reader.

15. The interaction method of claim 13, further comprising the act of adjusting attributes of said scene.

16. The interaction method of claim 15, wherein the adjusting act includes at least one of rotating a circular card and sliding a non-circular card.

17. The interaction method of claim 13, further comprising the act of selecting a scene from said scene data by positioning a portion of said card near a marker of said reader.

18. The interaction method of claim 13, wherein the activating act includes illuminating a room with at least one of light from at least one light source and projecting at least one image on at least one surface of said room.

19. The interaction method of claim 13, wherein the activating act includes illuminating a portion of at least one of said card and said reader with a light having attributes of a scene light illuminating a room.
